(19) United States
(12) Patent Application Publication
(10) Pub. No.: US 2006/0031168 A1
(43) Pub. Date: Feb. 9, 2006

(54) Method for access to multimedia content and a platform for implementation of the method

(75) Inventor: Didier Remi, Saint Series (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Prosodie SA, Boulogne Billancourt (FR)

(21) Appl. No.: 10/992,752

(22) Filed: Nov. 22, 2004

(30) Foreign Application Priority Data
Nov. 26, 2003 (FR) 03 50914

(51) Int. Cl. G06Q 99/00

(52) U.S. Cl. 705/52

(57) ABSTRACT

The invention relates to a method for access, for at least one user, to Internet site multimedia content, said method including, if the multimedia content is not free of charge:
a user identification test (8),
verification (13) that the user has or does not have an account containing access rights to the charged multimedia content, and
if the user has an account and sufficient rights, the delivery of the charged multimedia content (14),
   said user identification test (8) and said verification (13) being implemented by a proxy server software independent of the Internet site server software.

### TECHNICAL FIELD AND PRIOR ART

This invention relates to a method for access to multimedia content and a platform for implementation of the method.

The invention is applicable, for example, to the charging of a fee for services offered by the editors of multimedia content through communication networks.

Methods for providing users with authorization for consultation of Internet site multimedia content, in which the users have previously paid for access rights to this content, are known from the prior art. These methods are implemented by the server software of Internet sites containing multimedia content. Under these conditions, a change in the offers proposed by the Internet sites, or the introduction of new payment means requires the server software for the sites to be modified, which represents an inconvenience.

Methods for identifying users and controlling access rights are also known from the prior art. These methods are implemented for the purpose of filtering access to Internet site multimedia content so as to authorize access only to identified users. These methods have the disadvantage of not controlling user rights dynamically. In particular, they do not consider that each user's rights may be increased by the purchase of new rights or, conversely, reduced depending on the use of content and time.

The invention does not have the aforementioned disadvantages.

### DESCRIPTION OF THE INVENTION

Indeed, the invention relates to a method for access, for at least one user, to Internet site multimedia content. The method includes:
a request, by the user, for access to the multimedia content;
a multimedia content identification test to determine whether or not the multimedia content is charged,
if the multimedia content is not free of charge, an identification test for the user having made the request,
if the user is identified, it is verified that the user has or does not have an account containing access rights to the charged multimedia content, and
if the user has an account containing the access rights to the charged multimedia content, the charged multimedia content is provided to the user, and the user's account is debited for the rights providing access to the charged multimedia content,
   wherein said multimedia content identification test, said user identification test, said verification and said account debit are implemented by proxy server software independent of the Internet site server software.

According to an additional feature of the invention, the charged multimedia content is provided to the user by means of an Internet communication protocol.

According to another additional feature of the invention, the protocol for Internet communication is the HTTP protocol (HTTP for “HyperText Transfer Protocol”), or the FTP protocol (FTP for “File Transfer Protocol”), or the POP 3 protocol (POP for “Post Office Protocol”), or a protocol for broadcasting audiovisual content on the Internet such as, for example, the RTP protocol (RTP for “Real Time Protocol”) or an equivalent protocol.

According to yet another additional feature of the invention, if the multimedia content is not free of charge and if the user is not identified, a request for authentication or creation of an account by entering an account number is made by the proxy server software and addressed to the user.

According to yet another additional feature of the invention, if the user is authenticated, he or she provides an account number, and the proxy server software verifies whether or not the account number is valid.

According to yet another additional feature of the invention, if the user creates an account, the proxy server software verifies whether or not the account number entered is valid.

According to yet another additional feature of the invention, if the account number is valid, the proxy server software verifies whether the account associated with the account number contains access rights to the charged multimedia content, and information concerning the validity of the account number is recorded in a user right memory.

According to yet another additional feature of the invention, if the account number is invalid, a new request for authentication or for creation of an account by entering an account number is made by the proxy server software and addressed to the user.

According to yet another additional feature of the invention, if the multimedia content is not free of charge, if the user is identified and if the account does not have access rights to the charged multimedia content, at least one offer for the acquisition of rights is made by the proxy server software and addressed to the user.

According to yet another additional feature of the invention, if the user responds favourably to the offer:
the user purchases a ticket corresponding to the rights acquisition offer and a number of the ticket purchased is addressed to the user,
a request to enter the ticket number is addressed to the user, and
after the user has entered the ticket number, the validity of the ticket number is verified.

According to yet another additional feature of the invention, if the ticket number is valid:
the user's account is charged by the proxy server software for the rights corresponding to the ticket purchased,
the proxy server software verifies whether the user's account has sufficient credit to allow access to the charged multimedia content, and
if the user's account has sufficient credit, the charged multimedia content is provided to the user and the user's account is debited for the rights allowing access to the charged multimedia content.

According to yet another additional feature of the invention, if the user's account does not have sufficient credit, a new offer for acquisition of rights is made by the proxy server software and addressed to the user.

According to yet another additional feature of the invention, if the ticket number is invalid, a new request to enter the ticket number is made by the proxy server software and, after the user has entered the ticket number, the validity of the ticket number is verified.

According to yet another additional feature of the invention, the purchase of the ticket is carried out online, by telephone, short message, credit card, bank transfer, check or scratch card.

According to yet another additional feature of the invention, if the multimedia content is free of charge, it is provided to the user.

The invention also relates to a computer program stored on a data medium, characterized in that the program comprises instructions for implementation of the method for access to multimedia content according to the invention.

The invention also relates to a data medium readable by a computer system, characterized in that it contains computer program instructions for implementing a method for access to multimedia content according to the invention.

The invention also relates to a platform for access, for at least one user, to Internet site multimedia content. The platform includes a proxy server, a user offer memory and a user rights memory, wherein the proxy server is capable of:
receiving at least one request, from the user, for access to multimedia content,
performing a multimedia content identification test to determine, on the basis of information contained in the user offer memory, whether or not the multimedia content is charged,
if the multimedia content is charged, performing an identification test for the user making the request, on the basis of information contained in the user rights memory,
if the user is identified, verifying, on the basis of the information contained in the user rights memory, that the user has or does not have an account containing access rights to the charged multimedia content, and
if the user has an account containing access rights to the multimedia content, sending to a server of the Internet site a request to provide the user with the charged multimedia content and, once the charged multimedia content has been provided, debiting the user rights that allowed for access to the charged multimedia content, in the user rights memory.

According to another feature of the invention, the access platform includes a ticket server and a payment system so that if the user has an account without sufficient rights for access to the charged multimedia content, the proxy server invites the user to purchase a ticket at the ticket server and, once the ticket has been purchased by means of the payment system, the number of the purchased ticket is addressed to the user and validated, and the proxy server loads the user rights memory with rights corresponding to the purchased ticket.

The method for access to multimedia content according to the invention is implemented by a proxy server software of a fee-charging platform which is independent of the site containing the multimedia content. Advantageously, the modifications to the proxy server software do not necessarily lead to modifications in the Internet site server software. As a non-limiting example, free access multimedia content can thus become charged content without any modification to the Internet site server software containing the content.

The independence of the access method according to the invention from the Internet site also has other advantages, among which the following can be cited:
a capability of charging multimedia content regardless of the technology used to edit the multimedia content on the site;
a capability of charging a wide variety of multimedia content types (Web pages, electronic mail, FTP protocol, audio or video sequences, etc.);
the establishment of a variety of payment modes (bank card, calling a telephone number, short message (more commonly called SMS for “Short Message Service”), sending a check by mail, scratch card, etc.);
a capability to charge multimedia content independently of the protocol used to provide it to the user, due to the capability of the method of the invention to support a wide variety of Internet protocols such as, for example, the HTTP protocol, the FTP protocol, the POP 3 protocol, the protocols for broadcasting audiovisual content on the Internet such as, for example, the RTP protocol or the like, etc.;
a highly versatile back office function that enables the editors to easily manage and increase their commercial offers (variations in prices and/or rights offered).

The method according to the invention also enables a very wide variety of fee-charging modes to be managed, namely charging for the act, charging for time, or charging a package fee.

Charging for the act means the rights are debited, for example, according to the number of hits on charging pages, according to the size of the charging pages consulted, or according to a point evaluation scale assessed by the editor. Charging for time means the rights are debited according to the time spend navigating on charging pages. Charging a package fee means the rights are limitless for a period expressed in terms of a fixed date or a sliding period.

### BRIEF DESCRIPTION OF THE DRAWINGS

Other features and advantages of the invention will be discussed below in reference to the appended figures, in which

FIG. 1 shows a schematic diagram of the system for implementation of the method of the invention;

FIG. 2 shows a flow chart of the multimedia content access method according to the invention.

In all of the figures, the same references are used to designate the same elements.

### DETAILED DESCRIPTION OF THE EMBODIMENT OF THE INVENTION

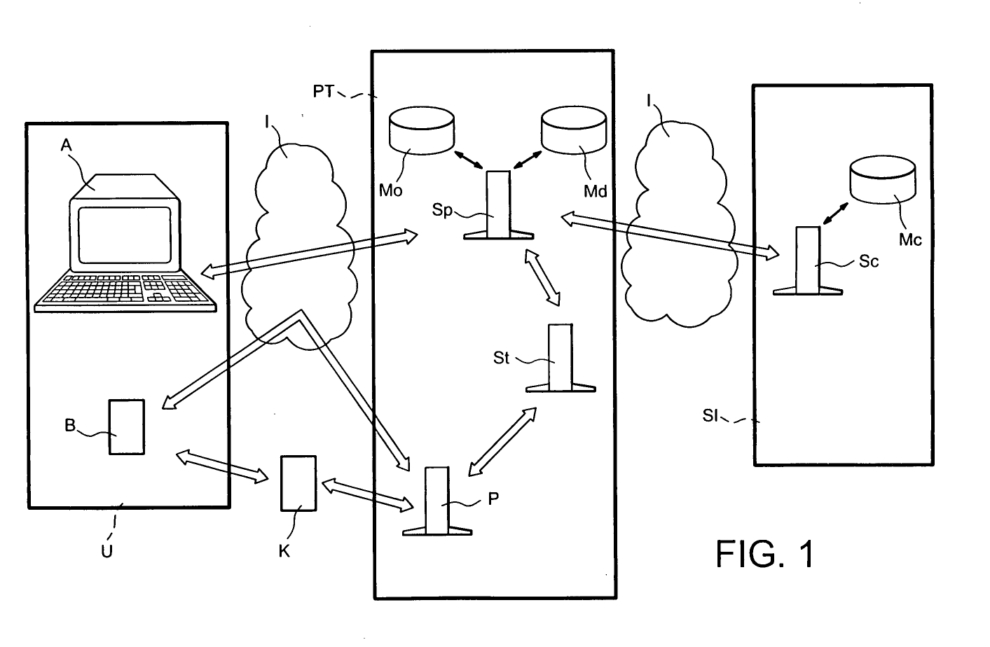

FIG. 1 shows a schematic diagram of the fee-charging system for implementation of the method of the invention.

The fee-charging system includes a fee-charging platform PT that establishes contact, via the Internet link I, between at least one user U and an Internet site SI. The user has a consultation station A and payment means B. The consultation station A is a personal computer more commonly known as PC (PC for “Personal Computer”). The Internet site SI includes a content server Sc and a content memory Mc. The content includes, for example, HTML pages, images, sounds, videos, files, and so on.

The fee-charging platform PT links the personal computer A to the content server Sc and to the content memory Mc. The fee-charging platform PT includes a proxy intermediation server Sp, a user offer memory Mo, a user rights memory Md, a ticket server St and a payment system P. The payment means B are put into contact with the payment system P either by the Internet link I, or by communication means K outside the platform PT and different from the Internet link I.

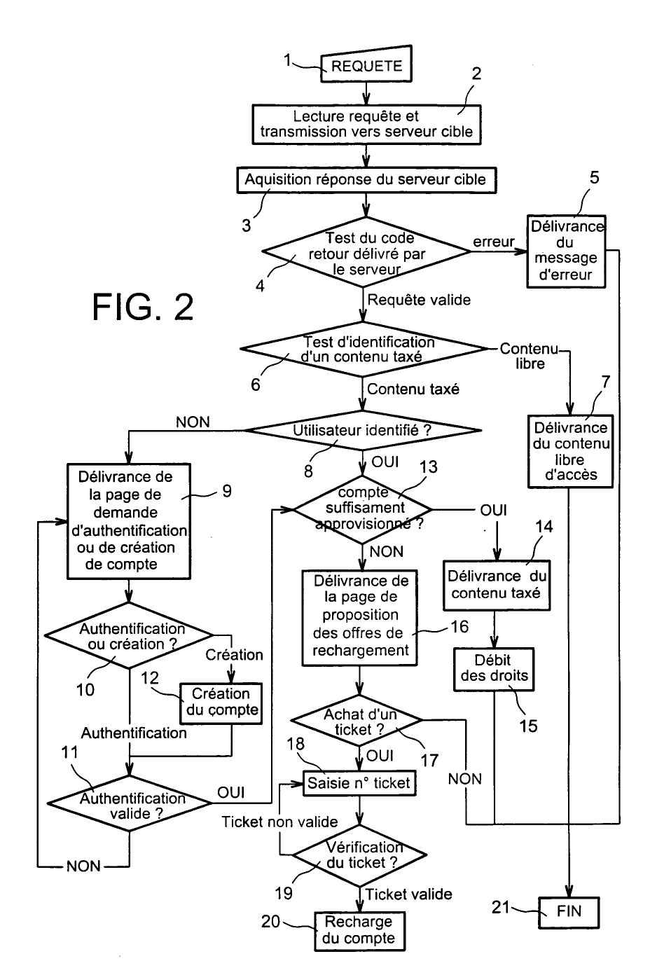

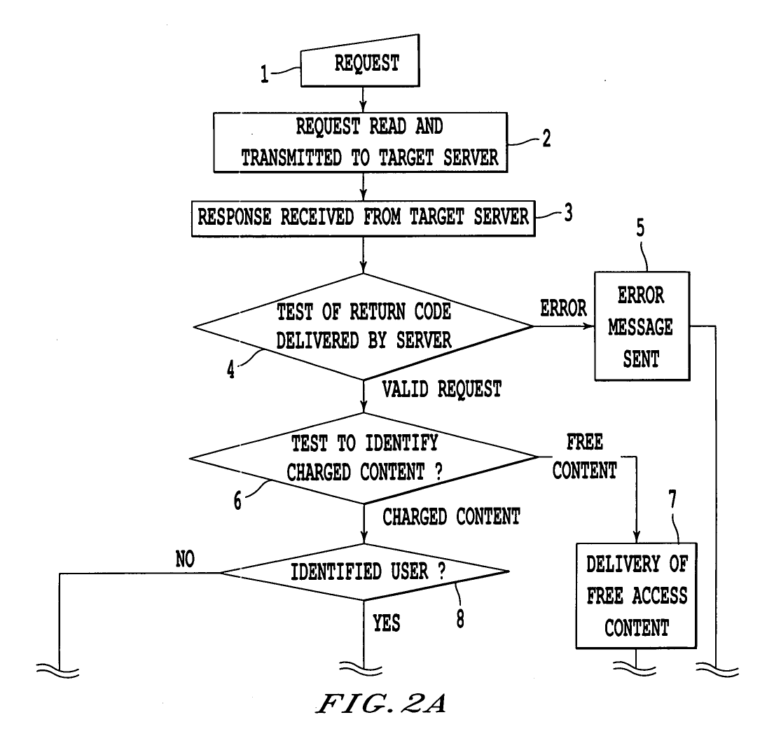

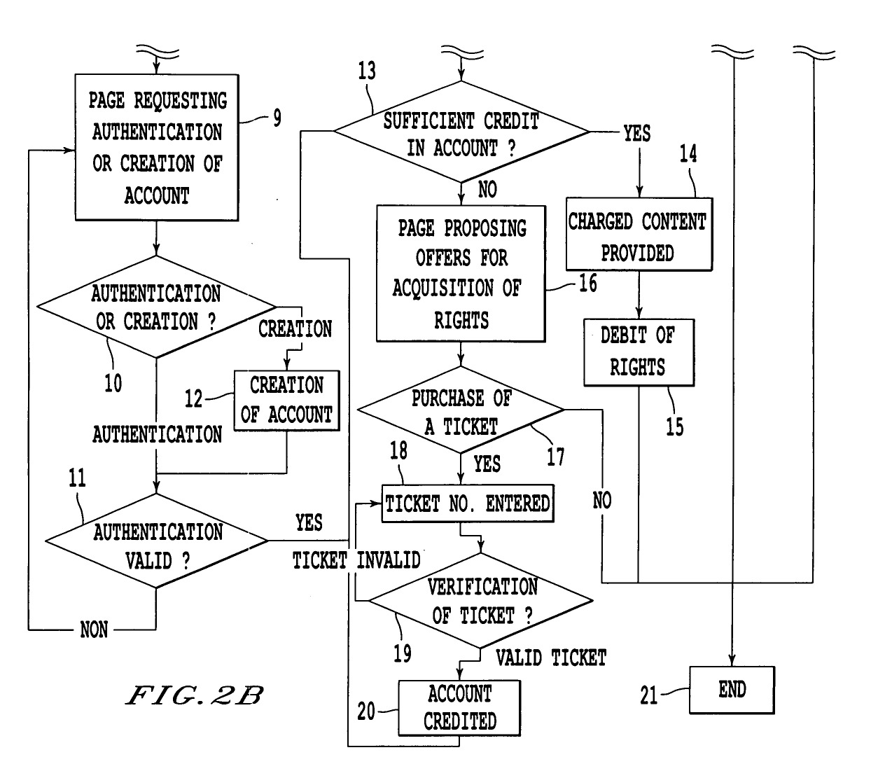

The method of the invention, which puts a user U in contact with the platform PT and the multimedia content of the Internet site SI, is described below. FIG. 2 shows a flow chart of the method of the invention. The proxy server Sp, to be active as follows, must first be declared in the domain name server or DNS server (DNS for “Domain Name System”) which references the server Sc of the Internet site. This declaration involves replacing the IP address of the Internet site server Sc with the IP address of the proxy server Sp.

A request to provide Internet site multimedia content is first transmitted by a user to the proxy server (step 1). The proxy server Sp reads the request and transmits it to the content server Sc (target server) (step 2). Next, is the acquisition by the proxy server Sp of the response from the content server Sc (step 3), and the test of the return code provided by the content server (step 4). The test of the return code results in the declaration that either the request is valid or an error has occurred. If it is declared that an error has occurred, the content server Sc sends an error message (step 5) and the method is terminated (step 21). If the request is declared valid, a test to identify the charged page is performed (step 6). It is then verified whether the multimedia content requested by the user has a fee. The information concerning whether or not the multimedia content has a fee is contained in the user offer memory Mo. More generally, the memory Mo contains all of the information concerning the offers that the Internet site SI provides to the users. The test to identify charged content then results in a declaration that the content either is or is not charged.

If there is free access to the content, it is provided at no cost to the user (step 7) and the method is terminated (step 21). If the content not free of charge, the proxy server Sp verifies whether the user has already been identified (user identification test/step 8) to determine whether the user is known to have rights to charged multimedia content. The information concerning the user's rights to charged multimedia content is recorded in the user rights memory Md.

If the user is not identified as having rights, said user is asked to provide authentication or to create an account (step 9). The authentication request involves requesting the user to provide an account number.

If the user provides an account number (step 10), an account is not created and the account number is checked for validity (step 11). The information concerning the validity of the account number is stored in the user rights memory Md. If the account number is invalid, the user is again asked to provide authentication or to create an account number (return to step 9). If the authentication is valid, it is verified that the account has sufficient credit (step 13). The information concerning credit in user accounts is stored in the memory Md.

If the user creates an account (step 12), the account number is likewise checked for validity (step 11) and, if the account number is invalid, the user is again asked to provide authentication or to create an account number (return to step 9). If the account number is valid, it is verified that the account has sufficient credit (step 13).

In every case, if the account has sufficient credit, the charged content is provided to the user (step 14), the rights used are debited (step 15) and the method is terminated (step 21).

If the account does not have sufficient credit, offers for acquisition of rights are made to the user (step 16). The rights acquisitions offers are stored in the user offer memory Mo. If the user does not respond to these offers, the method is terminated (step 21). If the user responds favourably to these offers, the user purchases a ticket for acquisition of rights equal to the offers that he or she has accepted (step 17). Contact between the user's payment means B and the payment system P for the ticket purchase can be established via the Internet link (for example, by transmitting a credit card number online) or by any other communication means (telephone call, short message (SMS message), credit card, check sent by mail, etc.). The payment system P is, for example, a credit card payment server, an Audiotel voice server, an SMS gateway, or the like. Once the ticket has been purchased, a ticket number is provided to the user, who is asked to enter said ticket number (step 18). The ticket number can be provided to the user by a wide variety of means (Internet link, telephone call, SMS short message, mail, etc.). The ticket is then validated so as to prevent fraud or detect any entry errors (step 19).

If the ticket number is invalid, the user is again asked to enter the ticket number (return to step 18). If the ticket number is valid, the account is provided with the rights acquired corresponding to the ticket purchased (step 20), and it is verified that the account has sufficient credit to obtain the charged content requested (step 13). If the account has sufficient credit, the charged content is provided (step 14), the rights used to authorize delivery of the charged content are debited (step 15) and the method is terminated (step 21). If the account does not have sufficient credit, the offer for acquisition of rights is again made to the user (return to step 16).

Steps 17, 18, 19 and 20 can then be repeated as necessary until the user's account has sufficient credit to allow for delivery of the charged content.

1. Method for access, for at least one user (U), to Internet site (SI) multimedia content, characterized in that it includes:
a request, by the user, for access (1) to the multimedia content
a multimedia content identification test (6) to determine whether or not the multimedia content is charged,
if the multimedia content is not free of charge, a user identification test (8) to identify the user who made the request,
if the user is identified, it is verified (13) that the user has or does not have an account containing the access rights to the charged multimedia content, and
if the user has an account containing access rights to the charged multimedia content, the charged multimedia content is provided to the user (14), and the user's account (15) is debited for the rights allowing access to the charged multimedia content,
wherein said multimedia content identification test (6), said user identification test (8), said verification (13) and said account debit (15) are implemented by proxy server software independent of the Internet site (SI) server software.

2. Method according to claim 1, characterized in that the charged multimedia content is delivered to the user by means of an Internet communication protocol.

3. Method according to claim 2, characterized in that the Internet communication protocol is the HTTP protocol, the FTP protocol, the POP 3 protocol, or a protocol for broadcasting audiovisual content on the Internet.

4. Method according to claim 3, characterized in that the protocol for broadcasting audiovisual content on the Internet is the RTP protocol.

5. Method according to claim 1, characterized in that, if the multimedia content is not free of charge and if the user is not identified, a request for authentication or to create an account by entering an account number (9) is made by the proxy server software and addressed to the user (U).

6. Method according to claim 5, characterized in that, if the user provides authentication (10), he or she provides an account number and the proxy server software verifies whether or not the account number is valid (11).

7. Method according to claim 5, characterized in that, if the user creates an account (12), the proxy server software verifies whether or not the account number entered is valid (11).

8. Method according to claim 6 or 7, characterized in that, if the account number is valid, the proxy server software verifies whether the account associated with the account number contains access rights to the charged multimedia content (13) and information concerning the validity of the account number is recorded in a user rights memory (Md).

9. Method according to claim 6 or 7, characterized in that, if the account number is invalid, a new request for authentication or to create an account by entering an account number (9) is made by the proxy server software and addressed to the user (U).

10. Method according to claim 1, characterized in that, if the multimedia content not free of charge, if the user is identified and if the account does not have access rights to the charged multimedia content, at least one offer for acquisition of rights (16) is made by the proxy server software and addressed to the user (U).

11. Method according to claim 10, characterized in that, if the user responds favourably to the offer:
the user (U) purchases a ticket (17) corresponding to the offer for acquisition of rights, and a number of the ticket purchased is addressed to the user,
a request for entry of the ticket number (18) is addressed to the user (U), and
after the user has entered the ticket number, it is verified that the ticket number is valid (19).

12. Method according to claim 11, characterized in that, if the ticket number is valid:
the user's account is provided (20), by the proxy server software, with the rights corresponding to the ticket purchased,
the proxy server software verifies that the user's account has sufficient credit to allow access to the charged multimedia content, and
if the user's account has sufficient credit, the charged multimedia content is provided to the user (14), and the user's account is debited (15) for the rights allowing access to the charged multimedia content.

13. Method according to claim 12, characterized in that, if the user's account does not have sufficient credit, a new offer for acquisition of rights (16) is made by the proxy server software and addressed to the user.

14. Method according to claim 11, characterized in that, if the ticket number is invalid, a new request to enter the ticket number (18) is made by the proxy server software and, after the user has entered the ticket number, it is verified that the ticket number is valid (19).

15. Method according to claim 11, characterized in that the purchase of the ticket (17) is carried out online, by a telephone call, SMS short message, credit card, bank transfer, check or scratch card.

16. Method according to claim 1, characterized in that, if the multimedia content is not charged, it is provided to the user (7) by means of an Internet communication protocol.

17. Computer program stored on a data medium, characterized in that the program comprises instructions for implementing the method for access to multimedia content according to any one of claims 1 to 16.

18. Data medium readable by a computer system, characterized in that it contains computer program instructions for implementation of the method for access to multimedia content according to one of claims 1 to 16.

19. Platform for access (PT), for at least one user (U), to Internet site (SI) multimedia content, characterized in that it includes a proxy server (Sp), a user offer memory (Mo) and a user rights memory (Md), wherein the proxy server (Sp) is capable of:
receiving, from the user, at least one request for access to multimedia content,
performing a test to identify multimedia content so as to determine, on the basis of information contained in the user offer memory (Mo), whether or not the multimedia content is charged,
if the multimedia content is not free of charge, performing a test to identify the user who made the request, on the basis of information contained in the user rights memory (Md),
if the user is identified, verifying, on the basis of information contained in the user rights memory (Md), that the user has an account containing access rights to the charged multimedia content, and
if the user has an account containing access rights to the multimedia content, sending to a sever (Sc) of said Internet site a request to provide the charged multimedia content to the user and, after the charged multimedia content has been provided, debiting, in the user rights memory (Md), the user's rights that allowed for access to the charged multimedia content.

20. Access platform (PT) according to claim 19, characterized in that it includes a ticket server (St) and a payment system (P) so that if the user (U) has an account with insufficient rights for access to the charged multimedia content, the proxy server (Sp) invites the user to purchase a ticket from the ticket server (St) and, once the ticket has been purchased by means of the payment system (P), a number of the purchased ticket is addressed to the user and validated, and the proxy server (Sp) provides the rights corresponding to the ticket purchased in the user rights memory (Md).
